(19) United States
(12) Patent Application Publication
(10) Pub. No.: US 2024/0292900 A1
(43) Pub. Date: Sep. 5, 2024

(54) AEROSOL GENERATION DEVICE

(71) Applicant: JAPAN TOBACCO INC., Tokyo (JP)

(72) Inventors: Mitsuhiro NAKATANI, Tokyo (JP); Manabu YAMADA, Tokyo (JP)

(73) Assignee: JAPAN TOBACCO INC., Tokyo (JP)

(21) Appl. No.: 18/665,622

(22) Filed: May 16, 2024

Related U.S. Application Data
(63) Continuation of application No. PCT/JP2021/042285, filed on Nov. 17, 2021.

(51) Int. Cl. A24F 40/465; A24F 40/20

(52) U.S. Cl. CPC A24F 40/465; A24F 40/20

(57) ABSTRACT

An aerosol generation device includes: a power supply; a conversion circuit configured to convert power supplied from the power supply into high frequency power; a magnetic body; an induction coil that is wound around the magnetic body and to which the high frequency power is supplied; and a susceptor in which an induction current generated by the induction coil and a magnetic field of the magnetic body flows. A cavity into which a stick including an aerosol source is configured to be inserted and extracted through an opening is formed in the aerosol generation device. The susceptor is provided in the cavity at an opening side when viewed from the induction coil.

### CROSS-REFERENCE TO RELATED APPLICATIONS

This is a continuation of International Application No. PCT/JP2021/042285 filed on Nov. 17, 2021, the entire content of which is incorporated herein by reference.

### TECHNICAL FIELD

The present disclosure relates to an aerosol generation device that generates aerosol by heating a stick.

### BACKGROUND ART

Aerosol generation devices using induction heating having an excellent heating efficiency have been known (JP2017-506915A, JP2021-065236A, JP6690862B, JP2019-526247A and JP2020-150959A). Such aerosol generation devices tend to have a larger size since more electronic components are needed in the induction heating than in the resistance heating. The aerosol generation devices disclosed in JP2017-506915A and JP2021-065236A generate aerosol by heating liquid and do not heat a stick including an aerosol source. In this regard, the aerosol generation devices disclosed in JP6690862B, JP2019-526247A and JP2020-150959A heat sticks including aerosol sources.

In the aerosol generation devices described in JP6690862B, JP2019-526247A and JP2020-150959A, since the susceptor and the induction coil wound around the ferromagnetic body are provided in the radial direction, the size of the aerosol generation device increases in the radial direction. Since many users of the aerosol generation device grip the aerosol generation device in the radial direction, such an increase in size in the radial direction may reduce the usability for the user.

### SUMMARY

An aspect of the present disclosure relates to providing an aerosol generation device capable of heating an entire stick while preventing the aerosol generation device from becoming thick in the radial direction.

According to aspects of the present disclosure, there is provided an aerosol generation device including:
a power supply;
a conversion circuit configured to convert power supplied from the power supply into high frequency power;
a magnetic body;
an induction coil that is wound around the magnetic body and to which the high frequency power is supplied; and
a susceptor in which an induction current generated by the induction coil and a magnetic field of the magnetic body flows and that is provided in the cavity, in which
a cavity into which a stick including an aerosol source is configured to be inserted and extracted through an opening is formed in the aerosol generation device, and
the susceptor is provided at an opening side when viewed from the induction coil.

According to aspect of the present disclosure, it is possible to heat the entire stick while preventing the aerosol generation device from becoming thick in the radial direction.

### BRIEF DESCRIPTION OF DRAWINGS

FIG. 1 is a perspective view of a non-combustion inhalation device;

FIG. 2 is a perspective view of the non-combustion inhalation device in the state in which a stick is attached thereto;

FIG. 3 is a block diagram showing the control configuration of the non-combustion inhalation device;

FIG. 4 is a perspective view of a heating unit according to a first embodiment;

FIG. 5 is an enlarged cross-sectional view of the heating unit according to the first embodiment;

FIG. 6 is a cross-sectional view showing the relationship between a magnetic body and a susceptor in the heating unit according to the first embodiment;

FIG. 7 is a cross-sectional view showing the relationship between a magnetic body and a susceptor in a heating unit according to a second embodiment;

FIG. 8 is a cross-sectional view showing the relationship between a magnetic body and a susceptor in a heating unit according to a third embodiment;

FIG. 9 is a perspective view of a heating unit according to a fourth embodiment;

FIG. 10 is an enlarged cross-sectional view of the heating unit according to the fourth embodiment; and

FIG. 11 is an explanatory view showing the flow of the induction current in a susceptor according to the fourth embodiment.

### DESCRIPTION OF EMBODIMENTS

### (Aerosol Generation Device)

Hereinafter, a non-combustion inhalation device will be described as an example of an aerosol generation device according to the present disclosure with reference to the drawings. A non-combustion inhalation device 100 (hereinafter, also simply referred to as “inhalation device 100”) according to the present embodiment generates the aerosol by heating a stick 500.

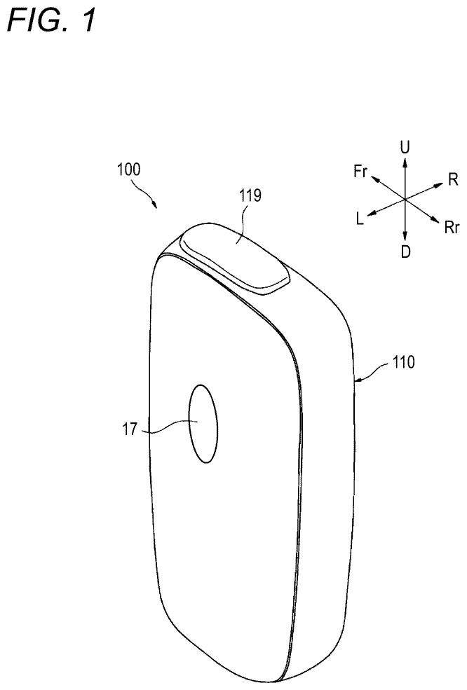

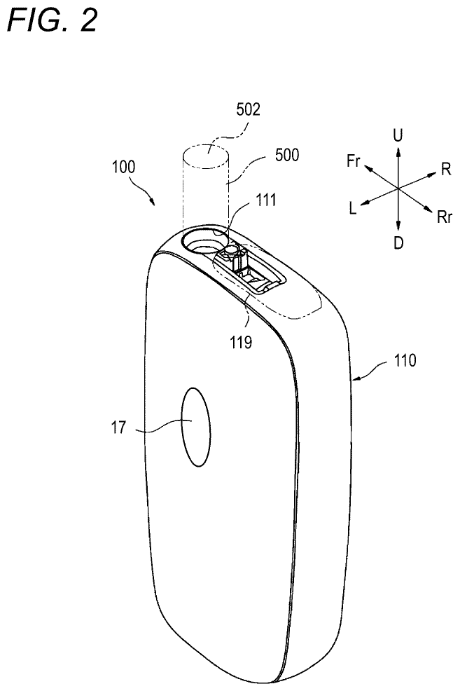

FIG. 1 is a perspective view showing an overall configuration of the inhalation device 100. FIG. 2 is a perspective view of the inhalation device 100 in the state in which the stick 500 is attached thereto. In the following description, for convenience, the orthogonal coordinate system in the three-dimensional space will be described in which three directions orthogonal to one another are defined as a front-rear direction, a left-right direction, and an upper-lower direction. In the drawings, the front side is indicated by Fr, the rear side is indicated by Rr, the right side is indicated by R, the left side is indicated by L, the upper side is indicated by U, and the lower side is indicated by D.

As shown in FIGS. 1 and 2, the inhalation device 100 generates the aerosol containing a flavor by heating the stick 500 that is elongated and substantially columnar and that serves as an example of a flavor component generating base material including a filler or the like containing an aerosol source and a flavor source.

The stick 500 includes a filler containing an aerosol source that generates the aerosol by being heated at a predetermined temperature. The type of the aerosol source is not particularly limited, and an extract substance from various natural products and/or a constituent component thereof may be selected according to the use. The aerosol source may be a solid, or may be, for example, a polyhydric alcohol such as glycerin or propylene glycol, or a liquid such as water. The aerosol source may include a flavor source such as a tobacco raw material that releases a flavor component by being heated, or an extract originated from a tobacco raw material. The gas to which the flavor component is added is not limited to the aerosol, and for example, invisible steam may be generated.

The filler of the stick 500 may contain cut tobacco as the flavor source. The material for the cut tobacco is not specifically limited, and the publicly known material such as a lamina and a stem may be used as the material. The filler may contain one type or two or more types of flavors. The types of flavors are not specifically limited, but in view of provision of the satisfactory smoke flavor, menthol is preferable. The flavor source may contain plants other than tobacco (for example, mints, herbal medicines, or herbs). Depending on the use, the stick 500 may not include the flavor source.

### (Non-Combustion Inhalation Device)

As shown in FIGS. 1 to 3, the inhalation device 100 includes a case 110, a power supply 10 provided in the internal space of the case 110, a control unit 120, and a heating unit 130. The case 110 has a substantially rectangular parallelepiped shape including a front surface, a rear surface, a left surface, a right surface, an upper surface, and a lower surface. The power supply 10 is a chargeable secondary battery, an electric double-layer capacitor, or the like, and is preferably a lithium ion secondary battery. The electrolyte of the power supply 10 may include one or a combination of a gel electrolyte, an electrolyte solution, a solid electrolyte, and an ionic liquid.

As shown in FIG. 2, the upper surface of the case 110 is formed with an opening 111 into which the stick 500 may be inserted, and a slider 119 that opens and closes the opening 111. The slider 119 is coupled to the case 110 in a manner of being movable in the front-rear direction between the position where the opening 111 is closed (see FIG. 1) and the position where the opening 111 is opened (see FIG. 2).

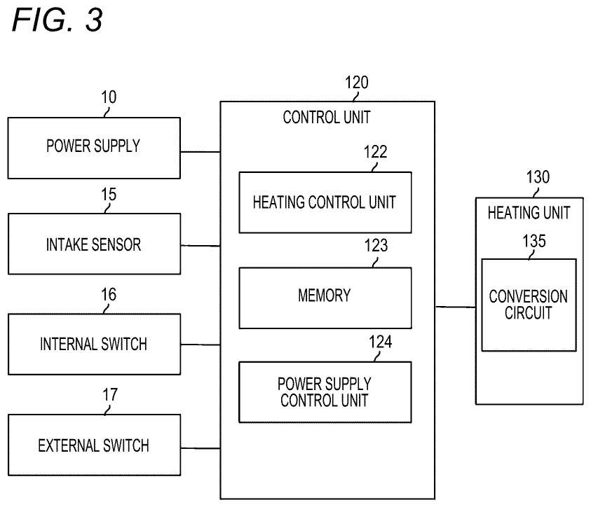

As shown in FIG. 3, the power supply 10, an intake sensor 15 that detects the puff (intake) operation, an internal switch 16 that detects insertion of the stick 500, and an external switch 17 that is provided outside the case 110 and that is to be operated by the user are connected to the input side of the control unit 120, and the heating unit 130 is connected to the output side of the control unit 120.

The inside of the control unit 120 includes, as the functional configurations implemented by cooperation of hardware and software, a heating control unit 122 that controls the heating unit 130 based on the switch signals of the internal switch 16 and the external switch 17, a memory 123 that stores the heating duration time of the heating unit 130, the number of times of the puff operation, and the like, and a power supply control unit 124 that manages charging and discharging of the power supply 10.

Specifically, the control unit 120 is a processor (a computer). More specifically, a structure of the processor is an electric circuit in which circuit elements such as a semiconductor device are combined. The intake sensor 15 may be implemented by a condenser microphone, a pressure sensor, or the like. Further, instead of detecting the puff by the intake sensor 15, the puff may be detected by sensing a temperature change of the heating unit 130 due to the puff using a thermistor.

The heating unit 130 heats the stick 500 inserted from the opening 111 without burning. When the stick 500 is heated, the aerosol is generated from the aerosol source contained in the stick 500, and the flavor of the flavor source contained in the stick 500 is added to the aerosol. The user may inhale the aerosol containing the flavor by holding in the mouth a suction port 502 of the stick 500 protruding from the opening 111 and perform suctioning.

(Heating Unit according to First Embodiment)

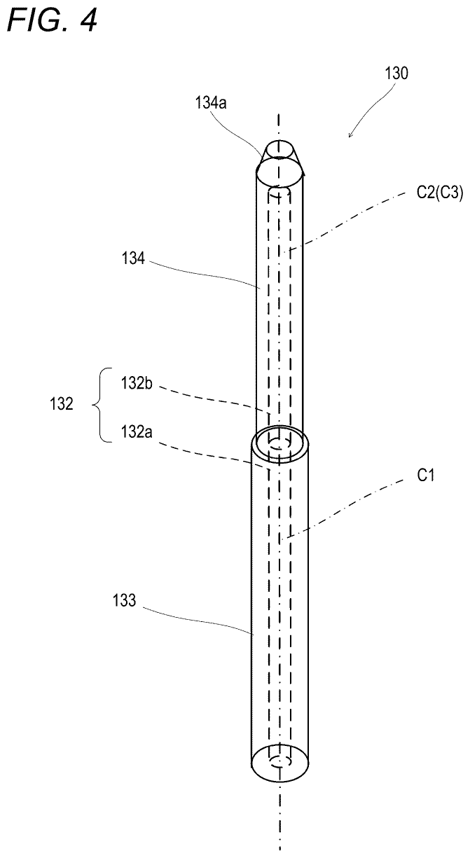

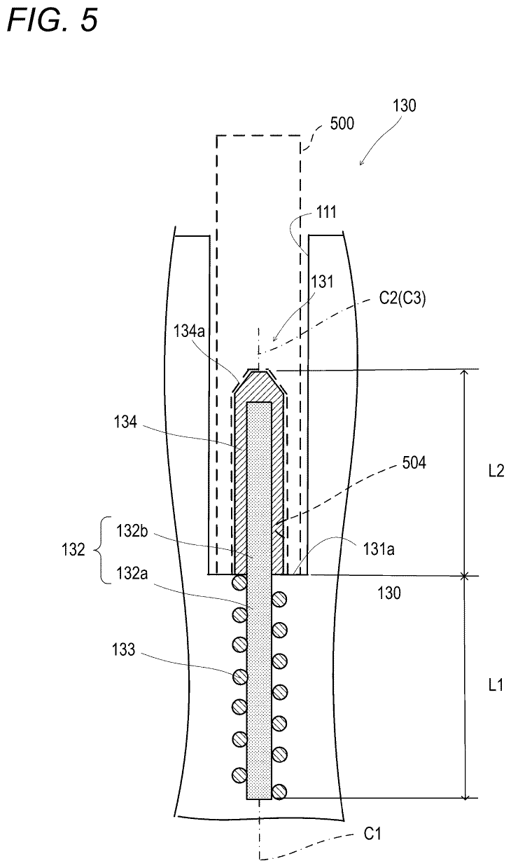

As shown in FIGS. 4 and 5, the heating unit 130 includes a conversion circuit 135 (see FIG. 3) that converts the power supplied from the power supply 10 into high frequency power, a cavity 131 through which the stick 500 may be inserted and extracted through the opening 111, a magnetic body 132 made of a ferromagnetic body such as a ferrite core, an induction coil 133 that is wound around the magnetic body 132 and to which the high frequency power is supplied, and a susceptor 134 through which the induction current (the eddy current) flows due to the magnetic flux generated by the induction coil 133 and that converts the induction current into Joule heat (generates heat due to hysteresis loss). The heating unit 130 heats the stick 500 by so-called induction heating.

By using the magnetic body 132 in the induction heating, the directivity of the magnetic flux generated by the induction coil 133 is improved by the magnetic body 132, and the efficiency of the induction heating is improved as the magnetic flux density penetrating the susceptor 134 increases. Further, the magnetic body 132 is magnetized by the magnetic flux generated by the induction coil 133 penetrating the magnetic body 132, and the magnetic flux density penetrating the susceptor 134 also increases due to the magnetic flux emitted from the magnetic body 132.

The susceptor 134 is a conductive member whose cross section in a plane orthogonal to the longitudinal direction has a circular shape, and is provided in the cavity 131 such that the longitudinal direction coincides with the insertion and extraction direction of the stick 500 and the susceptor 134 protrudes from a bottom surface portion 131a of the cavity 131 toward the opening 111. A recess 504 into which the susceptor 134 is fitted when the stick 500 is inserted into the cavity 131 is formed in the distal end surface portion of the stick 500 in the insertion direction, and the stick 500 is heated from the inner peripheral side by heating the susceptor 134 fitted into the recess 504 by induction heating. A protrusion 134a having a diameter decreasing toward the distal end side is formed on the end portion of the susceptor 134 on the opening 111 side, and the protrusion 134a functions as a fitting guide when the stick 500 is fitted into the recess 504. The protrusion 134a may be any portion having a shape different from the cylindrical shape of the main body of the susceptor 134. The shape of the susceptor 134 is not limited to the cylindrical shape, and may be a prismatic shape or a flat plate shape. The protrusion 134a may have a needle shape, a pyramid shape, a cylindrical shape, a trapezoid shape, or the like.

The magnetic body 132 is a ferromagnetic member having a cylindrical shape whose cross section in the plane orthogonal to the longitudinal direction has the circular shape, and the longitudinal direction coincides with the insertion and extraction direction of the stick 500. The magnetic body 132 according to the present embodiment includes a coil winding portion 132a around which the induction coil 133 is wound, and an extending portion 132b extending to the inside of the susceptor 134. The magnetic body 132 is implemented only by the coil winding portion 132a, and the extending portion 132b may be omitted. However, by providing the extending portion 132b, more magnetic flux may pass through the susceptor 134, and the entire stick may be heated.

The shape of the magnetic body 132 is not limited to a cylindrical shape, and may be a prismatic shape or a flat plate shape. Such a simple shape may reduce the manufacturing cost. However, by forming the magnetic body 132 into the cylindrical shape, the magnetic field generated by the magnetic body 132 and the induction coil 133 has the isotropic property. Therefore, the heating efficiency of the stick 500 may be made constant with respect to the angle of the stick 500 in the rolling direction when the stick 500 is inserted into the cavity 131. The magnetic body 132 is made of, for example, ferrite.

The induction coil 133 is wound around the coil winding portion 132a of the magnetic body 132, and generates the magnetic flux in response to application of the high frequency power. Most of the magnetic flux generated by the induction coil 133 reaches the susceptor 134 through the magnetic body 132 and causes the susceptor 134 to generate the induction current. In the induction coil 133 wound around the coil winding portion 132a of the magnetic body 132, a center line C1 passing through the center of the coil coincides with the insertion and extraction direction of the stick 500. The induction coil 133 is aligned with the susceptor 134 in the insertion and extraction direction of the stick 500.

That is, the susceptor 134 is provided on the opening 111 side when viewed from the induction coil 133. In other words, the susceptor 134 is provided between the induction coil 133 and the opening 111 in the insertion and extraction direction of the stick 500. Therefore, it is possible to cause the magnetic flux amplified by the magnetic body 132 to pass through the susceptor 134 while preventing the inhalation device 100 from becoming thicker in the radial direction. Accordingly, it is possible to efficiently heat the stick 500 while reducing the size of the inhalation device 100.

The induction coil 133 is not wound around the susceptor 134. In this way, not only may the shape of the induction coil 133 be avoided from becoming complicated, but also there is no need to expose the induction coil 133 inside the cavity 131, and the size and the cost of the inhalation device 100 may be reduced.

In the present embodiment, when the induction coil 133 and the susceptor 134 are arranged in a line in the insertion and extraction direction of the stick 500, a virtual line C2 obtained by extending the center line C1 of the induction coil 133 toward the opening 111 overlaps a center line C3 of the susceptor 134. In this way, the magnetic flux generated by the induction coil 133 and the magnetic body 132 may easily pass through the center of the susceptor 134, and a large amount of magnetic flux may pass through the susceptor 134.

Since the magnetic body 132 extends to the inside of the susceptor 134, more magnetic flux may pass through the susceptor 134. In the present disclosure, “A extends to B” means that at least a part of A overlaps B in the insertion and extraction direction of the stick 500, and “A does not extend to B” means that A does not overlap B in the insertion and extraction direction.

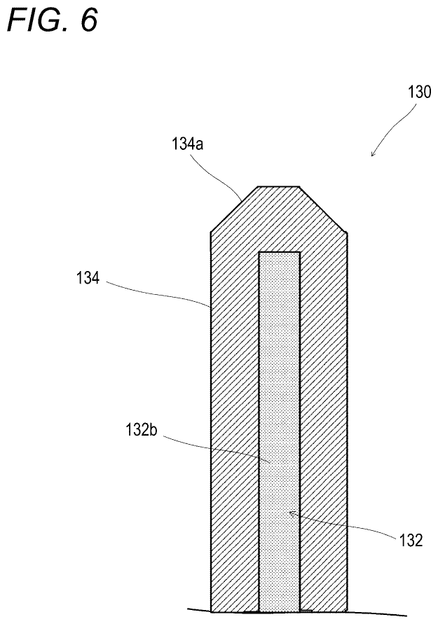

In the present embodiment, as shown in FIG. 6, when the magnetic body 132 is extended to the inside of the susceptor 134, the magnetic body 132 is prevented from extending to the protrusion 134a of the susceptor 134. In this way, it is possible to simplify the shape of the magnetic body 132 as compared with the case in which the magnetic body 132 is extended to the protrusion 134a of the susceptor 134.

Further, in the present embodiment, as shown in FIG. 5, a length L1 of the induction coil 133 in the insertion and extraction direction of the stick 500 is larger than a length L2 of the susceptor 134 in the same direction. In this way, the magnetic field having a high magnetic flux density may be generated by the long induction coil 133, and thus the generation amount and the generation efficiency of the aerosol may be improved. The length L1 of the induction coil 133 in the insertion and extraction direction of the stick 500 may be smaller than the length L2 of the susceptor 134 in the same direction. In this case, it is easier to heat the stick 500 over the entire length by the long susceptor 134, and thus the generation amount and the generation efficiency of the aerosol may be improved.

### (Heating Unit According to Second Embodiment)

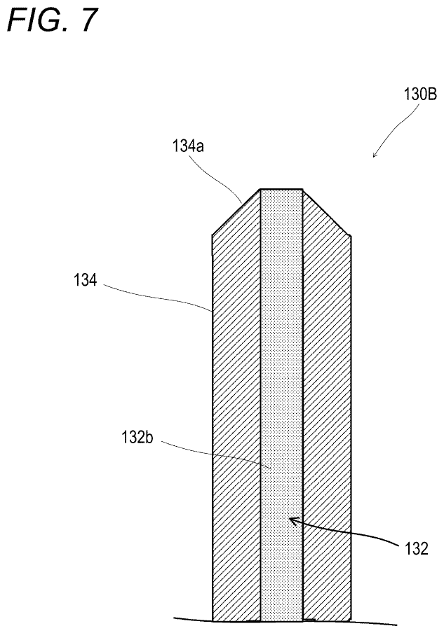

Next, heating units 130B to 130D according to second to fourth embodiments will be described with reference to FIGS. 7 to 11. However, for the configurations common to those according to the above embodiment, the same reference signs as those in the above embodiment are used, and the description of the above embodiment may be referred to.

As shown in FIG. 7, the heating unit 130B according to the second embodiment is different from the first embodiment in that the magnetic body 132 is extended to the distal end surface of the protrusion 134a of the susceptor 134 when the magnetic body 132 is extended to the inside of the susceptor 134. In this case, since the magnetic flux may pass to the end of the susceptor 134, the heating efficiency of the stick 500 may be improved.

### (Heating Unit According to Third Embodiment)

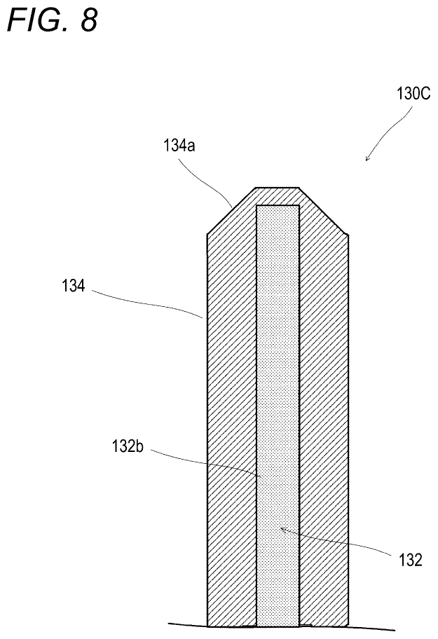

As shown in FIG. 8, a heating unit 130C according to the third embodiment is different from the second embodiment in that the magnetic body 132 is extended to the protrusion 134a of the susceptor 134 when the magnetic body 132 is extended to the inside of the susceptor 134, but the magnetic body 132 is not extended to the distal end surface of the protrusion 134a. In this way, not only may the magnetic flux pass over substantially the entire length of the susceptor 134, but also impurities and liquids are less likely to enter from the interface between the magnetic body 132 and the susceptor 134. Accordingly, the durability of the inhalation device 100 is improved, and the operation thereof is stabilized.

### (Heating Unit According to Fourth Embodiment)

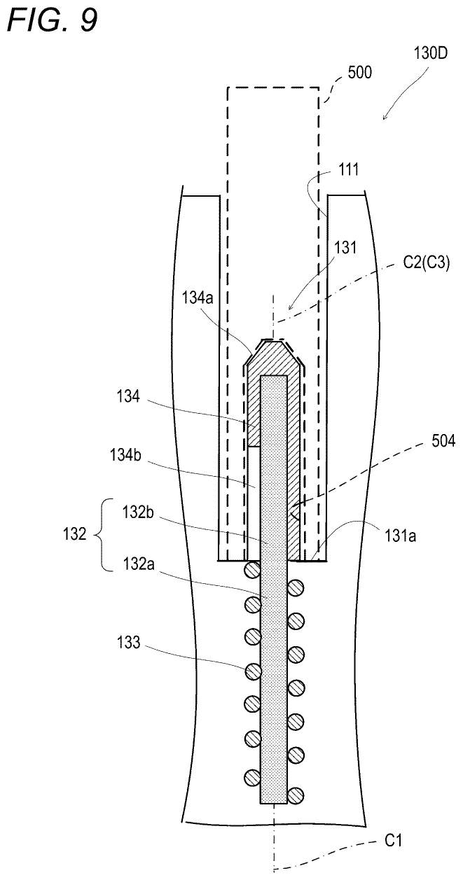

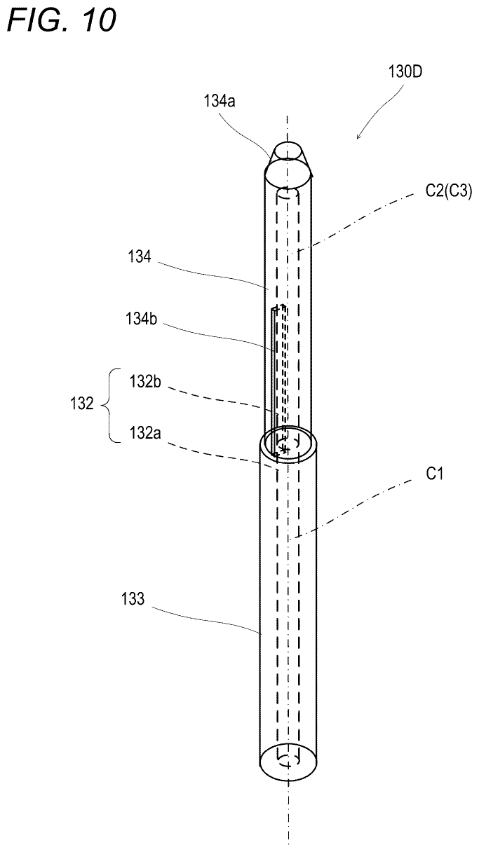

As shown in FIGS. 9 and 10, the heating unit 130D according to the fourth embodiment is different from the above embodiment in that the susceptor 134 has a slit 134b extending in the insertion and extraction direction of the stick 500. In the heating units 130, 130B, and 130C according to the above embodiments, the magnetic flux density penetrating the susceptor 134 increases due to the magnetic body 132. Alternatively, the magnetic flux density may still decrease in the susceptor 134 from the side close to the induction coil 133 toward the side far away from the induction coil 133. When such a bias in magnetic flux density occurs, the induction current is concentrated near the root of the susceptor 134 close to the induction coil 133, and the temperature gradient occurs in the susceptor 134 in which the temperature is high near the root of the susceptor 134 and the temperature decreases as the distance from the induction coil 133 increases. When the temperature gradient occurs in the susceptor 134, the stick 500 cannot be uniformly heated, and the aerosol generation efficiency may deteriorate.

Therefore, in the present embodiment, by forming the slit 134b extending in the insertion and extraction direction of the stick 500 in the susceptor 134, the flow of the induction current in the susceptor 134 is improved by the slit 134b, and the temperature gradient that is likely to occur in the longitudinal direction of the susceptor 134 is reduced.

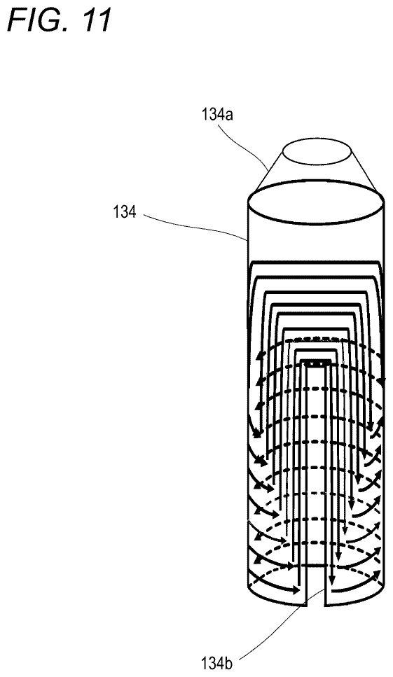

It is preferable that the end portion of the slit 134b on the opening 111 side does not extend to the protrusion 134a of the susceptor 134. It is preferable that the end portion of the slit 134b on the induction coil 133 side extends to the end portion (the end surface) of the susceptor 134 on the induction coil 133 side. In this way, as shown in FIG. 11, the induction current that is likely to concentrate on the induction coil 133 side of the susceptor 134 flows around the opening 111 side to bypass the slit 134b. Accordingly, the induction current may flow from the root side to the distal end side of the susceptor 134, and the temperature gradient of the susceptor 134 may be further reduced.

An insulating member (not shown) may be provided in the slit 134b. In other words, the slit 134b may be filled with an insulating member. As a specific example, epoxy resin may be used for this insulating member. In this way, since entry of the foreign matter from the slit 134b may be prevented, the durability of the inhalation device 100 may be improved. In the example shown in FIGS. 9 to 11, the slit 134b is formed at only one location in the circumferential direction. Alternatively, the slit 134b may be formed at two or more locations. Ceramic or glass having better heat resistance than epoxy resin may be used for the insulating member.

Although various embodiments have been described above with reference to the drawings, it is needless to say that the present disclosure is not limited to these examples. It is apparent to a person skilled in the art that various changes and modifications may be conceived within the scope described in the claims, and it is understood that the changes and the modifications naturally fall within the technical scope of the present invention. In addition, the components described in the above embodiments may be freely combined without departing from the spirit of the invention.

In the present specification, at least the following matters are described. In parentheses, corresponding components and the like in the above embodiment are shown, but the present disclosure is not limited thereto.

(1) An aerosol generation device including:
a power supply (power supply 10);
a conversion circuit (conversion circuit 135) configured to convert power supplied from the power supply into high frequency power;
a magnetic body (magnetic body 132);
an induction coil (induction coil 133) that is wound around the magnetic body and to which the high frequency power is supplied; and
a susceptor (susceptor 134) in which an induction current generated by the induction coil and a magnetic field of the magnetic body flows,
in which a cavity (cavity 131) into which a stick (stick 500) including an aerosol source is configured to be inserted and extracted through an opening (opening 111) is formed in the aerosol generation device, and
   the susceptor is provided in the cavity at an opening side when viewed from the induction coil.

According to (1), by arranging the induction coil and the susceptor in a line, it is possible to cause the magnetic flux amplified by the magnetic body to pass through the susceptor while preventing the aerosol generation device from becoming thick in the radial direction. Accordingly, it is possible to heat the entire stick while reducing the size of the aerosol generation device.

(2) The aerosol generation device according to (1),
in which the magnetic body extends to an inside of the susceptor.

According to (2), since more magnetic flux may pass through the susceptor by the magnetic body extending to the inside of the susceptor, the entire stick may be heated.

(3) The aerosol generation device according to (2),
in which the susceptor has a protrusion (protrusion 134a) at an end portion on the opening side, and
the magnetic body does not extend to the protrusion.

According to (3), as compared with the case in which the magnetic body is extended to the protrusion of the susceptor, the shape of the magnetic body may be simplified, and thus the cost of the aerosol generation device may be reduced.

(4) The aerosol generation device according to any one of (1) to (3),
in which the magnetic body has a flat plate shape or a cylindrical shape.

According to (4), the magnetic body having a simple shape may be used, and the cost of the aerosol generation device may be reduced.

(5) The aerosol generation device according to (2),
in which the susceptor has a protrusion (protrusion 134a) at an end portion on the opening side, and
the magnetic body extends to the protrusion.

According to (5), as compared to the case in which the magnetic body is not extended to the protrusion of the susceptor, the magnetic flux may pass over the entire length of the susceptor, and thus the entire stick may be heated.

(6) The aerosol generation device according to (5),
in which the magnetic body extends to a distal end surface of the protrusion.

According to (6), since the magnetic flux may pass to the end of the susceptor, the entire stick may be heated.

(7) The aerosol generation device according to (5),
in which the magnetic body does not extend to a distal end surface of the protrusion.

According to (7), since impurities and liquids are less likely to enter from the interface between the magnetic body and the susceptor, the durability of the aerosol generation device is improved and the operation thereof is stabilized.

(8) The aerosol generation device according to any one of (1) to (7),
in which a virtual line (virtual line C2) obtained by extending a center line (center line C1) of the induction coil extending in an insertion and extraction direction of the stick toward the opening side overlaps a center line (center line C3) of the susceptor extending in the insertion and extraction direction.

According to (8), the magnetic flux amplified by the magnetic body easily passes through the center of the susceptor, and a large amount of magnetic flux may pass through the susceptor.

(9) The aerosol generation device according to any one of (1) to (8),
in which the induction coil is not wound around the susceptor.

According to (9), since the shape of the induction coil is complicated and there is no need to expose the induction coil to the cavity, the size and the cost of the aerosol generation device may be reduced.

(10) The aerosol generation device according to any one of (1) to (9),
in which a length (length L1) of the induction coil in an insertion and extraction direction of the stick is smaller than a length (length L2) of the susceptor in the insertion and extraction direction.

According to (10), it is easier to heat the stick over the entire length by the long susceptor, and thus the generation amount and the generation efficiency of the aerosol may be improved.

(11) The aerosol generation device according to any one of (1) to (9),
in which a length (length L1) of the induction coil in an insertion and extraction direction of the stick is larger than a length (length L2) of the susceptor in the insertion and extraction direction.

According to (11), the magnetic field having a high magnetic flux density may be generated by the long induction coil, and thus the generation amount and the generation efficiency of the aerosol may be improved.

(12) The aerosol generation device according to any one of (1) to (11),
in which the susceptor has a gap (slit 134b) extending in an insertion and extraction direction of the stick.

According to (12), the flow of the induction current in the susceptor may be improved by the gap, and thus the entire stick may be uniformly heated.

(13) The aerosol generation device according to (12),
in which the susceptor has a protrusion (protrusion 134a) at an end portion on the opening side, and the gap does not extend to the protrusion.

According to (13), the induction current that is likely to concentrate near the root of the susceptor may flow to other portions of the susceptor, and thus the entire stick may be appropriately heated.

(14) The aerosol generation device according to (12) or (13),
in which the susceptor has a protrusion (protrusion 134a) at an end portion on the opening side, and the gap extends to an end portion of the susceptor on a side different from the opening side.

According to (14), the induction current that is likely to concentrate near the root of the susceptor may flow to other portions of the susceptor, and thus the entire stick may be appropriately heated.

(15) The aerosol generation device according to any one of (12) to (14),
in which an insulating member is provided at at least a part of the gap.

According to (15), since entry of the foreign matter from the slit may be prevented, the durability of the aerosol generation device is improved and the operation thereof is stabilized.

What is claimed is:

1. An aerosol generation device comprising:
a power supply;
a conversion circuit configured to convert power supplied from the power supply into high frequency power;
a magnetic body;
an induction coil that is wound around the magnetic body and to which the high frequency power is supplied; and
a susceptor in which an induction current generated by the induction coil and a magnetic field of the magnetic body flows,
wherein a cavity into which a stick including an aerosol source is configured to be inserted and extracted through an opening is formed in the aerosol generation device, and
wherein the susceptor is provided in the cavity at an opening side when viewed from the induction coil.

2. The aerosol generation device according to claim 1,
wherein the magnetic body extends to an inside of the susceptor.

3. The aerosol generation device according to claim 2,
wherein the susceptor has a protrusion at an end portion on the opening side, and
wherein the magnetic body does not extend to the protrusion.

4. The aerosol generation device according to claim 1,
wherein the magnetic body has a flat plate shape or a cylindrical shape.

5. The aerosol generation device according to claim 2,
wherein the susceptor has a protrusion at an end portion on the opening side, and
wherein the magnetic body extends to the protrusion.

6. The aerosol generation device according to claim 5,
wherein the magnetic body extends to a distal end surface of the protrusion.

7. The aerosol generation device according to claim 5,
wherein the magnetic body does not extend to a distal end surface of the protrusion.

8. The aerosol generation device according to claim 1,
wherein a virtual line obtained by extending a center line of the induction coil extending in an insertion and extraction direction of the stick toward the opening side overlaps a center line of the susceptor extending in the insertion and extraction direction.

9. The aerosol generation device according to claim 1,
wherein the induction coil is not wound around the susceptor.

10. The aerosol generation device according to claim 1,
wherein a length of the induction coil in an insertion and extraction direction of the stick is smaller than a length of the susceptor in the insertion and extraction direction.

11. The aerosol generation device according to claim 1,
wherein a length of the induction coil in an insertion and extraction direction of the stick is larger than a length of the susceptor in the insertion and extraction direction.

12. The aerosol generation device according to claim 1,
wherein the susceptor has a gap extending in an insertion and extraction direction of the stick.

13. The aerosol generation device according to claim 12,
wherein the susceptor has a protrusion at an end portion on the opening side, and
wherein the gap does not extend to the protrusion.

14. The aerosol generation device according to claim 12,
wherein the susceptor has a protrusion at an end portion on the opening side, and
wherein the gap extends to an end portion of the susceptor on a side different from the opening side.

15. The aerosol generation device according to claim 12,
wherein an insulating member is provided at at least a part of the gap.
